(19) United States
(12) Patent Application Publication
(10) Pub. No.: US 2004/0037469 A1
(43) Pub. Date: Feb. 26, 2004

(54) Object-oriented control of information and advertisement supports

(76) Inventors: Martin Werner, Hemer (DE); Michael Rinne, Dortmund (DE); Stefan Ghelen, Bochum (DE)

Correspondence Address: IP Strategies, Suite 500, 1730 North Lynn Street, Arlington, VA, 22209, US

(21) Appl. No.: 10/297,048

(22) PCT Filed: Jun. 1, 2001
(86) PCT No.: PCT/EP01/06256

(30) Foreign Application Priority Data
Jun. 2, 2000 (DE) 10027365.3

(51) Int. Cl. G06K 9/62

(52) U.S. Cl. 382/224; 382/103

(57) ABSTRACT

The invention relates to a device for the object-oriented control of at least one information display device, comprising at least one sensor device for detecting an object or a group of objects; and a control means. The invention is characterized in that the control means is configured for determining at least one classification feature of at least one object or of the group of objects detected by the sensor device and for controlling the at least one information display device on the basis of the at least one determined classification feature. The invention additionally relates to a system comprising at least one information display device; and a device for the object-oriented control of the at least one information display device of the type described hereinbefore.,

### FIELD OF THE INVENTION

The invention relates to a device for the object-oriented control of information display devices (e.g. advertising carriers). In particular, the invention relates to a device for the object-oriented control of information display devices comprising at least one sensor device for detecting an object or a group of objects, and a control means. The invention additionally relates to a system comprising an information display device together with such devices for the object-oriented control of information display devices.

The items of information can vary very widely. Common examples are replies to queries, hints, assistance, in particular also advertisements and mixed forms of these aforementioned types of information. The objects in question are primarily persons, but may also be objects such as vehicles.

### PRIOR ART

Devices for controlling information display devices are known from the prior art.

The automatic control is, however, limited to simple triggering mechanisms which reproduce stored information in dependence upon the presence or the movement of objects. A known technical embodiment of such a triggering mechanism is a movement detector.

The prior art does, however, not disclose any devices for an object-oriented control of information display devices, which permit an individual adaptation of the information reproduced.

It is therefore the object of the present invention to provide a device for the object-oriented control of at least one Information display device, which permits an individual and automatic adaptation of the information reproduced.

### DESCRIPTION OF THE INVENTION

This object is achieved by a device of the type mentioned at the beginning, which is characterized in that the control means is configured for determining at least one classification feature of the object or group of objects detected by the at least one sensor device and for controlling the at least one information display device on the basis of the at least one determined classification feature.

According to a preferred further development of the present invention, the at least one sensor device comprises at least one video camera for recording video images, and the control means is configured for determining the at least one classification feature from recorded video images of the detected object or group of objects. This has the advantage that, due to the fact that the detection is extended to the visual sphere, a broader spectrum of classification features is available, and this permits a better individual adaptation of the information to be displayed.

In order to permit a more reliable determination of classification features, the control means is, in an advantageous manner, configured for determining the at least one classification feature by averaging a plurality of recorded video images of the detected object or group of objects.

This will be particularly advantageous especially in cases where the objects are moving objects or persons. Such objects or persons may be taken at a disadvantageous angle of view in individual video images so that the determination of certain classification features will actually only be possible on the basis of an evaluation of a plurality of video images.

According to a specially preferred embodiment, the control means is configured such that it is provided for person-oriented control of the at least one information display device and that the at least one classification feature of the detected person or group of persons is determined with the aid of a biometric method, since such methods are excellently suitable for determining person-oriented classification features.

According to a preferred embodiment, the biometric method comprises a face recognition method, since by means of this method it is normally possible to determine more and/or more specific classification features than by means of other methods.

In the case of some biometric methods and especially in the case of face recognition it is possible to judge whether a person looks or does not look at an information offered to him on an information display device. The information display device can be controlled in response thereto. The attention of a person can, in this way, be directed to the information display device e.g. by flashing signals, etc..

Alternatively or in addition to the above-mentioned methods, identification marks (e.g. electronic tags, remotely readable boarding cards, name tags, registration numbers, 2d bar codes, etc.) can be provided for objects/persons, said identification marks being adapted to be detected by the at least one sensor device and used as a classification feature by the control means.

Such identification marks allow a complete identification of persons or at least a determination of relevant person-oriented data and, consequently, they permit an optimum adaptation of the displayed information to a person or a group of persons,

The information reproduced can be information presented to the person in question, e.g. individually adapted orientation assistance or advertisements, but also information concerning the person in question, which Is made available e.g. to service staff.

In this respect, many fields of use are imaginable, for example: airports, railways stations, public offices, office buildings, hospitals, industrial sites, security-relevant plants, etc..

Furthermore, the invention can be used e.g. in parking garage guide systems; in this case, existing identification marks (e.g. vehicle registration numbers) or specially provided identification marks on vehicles are used as a classification feature.

For persons the classification features can preferably comprise the sex and/or age and/or height and/or weight and/or colour of the skin and/or hair colour and/or nature of dress and/or the ethnic affiliation and/or the pose of the respective person. This allows the information to be displayed to be optimally adapted to individual persons and also to groups of several persons.

Quite generally, visual evaluation methods can be used, which evaluate separately or in combination object properties such as colour, texture, projected shapes, or three-dimensional shapes, etc., for determining classification features.

In accordance with a specially preferred further development of the device, the control means executes a statistical evaluation of the determined classification features of the detected object or group of objects for determining statistical data.

In cases in which groups of objects and, especially, groups of persons were detected, this statistical evaluation comprises, in a particularly advantageous manner, averaging over the respective group.

In an advantageous embodiment, the control means selects the information to be displayed on the basis of the determined statistical data.

According to another further development of the above-described devices, the control means stores the statistical data and makes them available to an external evaluation means, e.g. for determining the advertising appeal of the displayable information. This permits an optimum adaptation of the displayed information to individual persons or groups of persons.

In accordance with another advantageous embodiment, the above-described devices additionally comprise an input device which is connected to the control means via a data line (if desired, the Input device can, of course, also be integrated in the control means). This input device is adapted to have entered therein a person- or object-oriented information (in certain fields of use also by the respective person himself), said control means correlating the entered information with the at least one classification feature determined by the at least one sensor device for said specific person or an associated object (e.g. the person's motor vehicle).

This information can either be entered manually, e.g. in the form of a PIN, or it can be automatically readable information in the form of a code provided on an identification card. If an identification mark of the type described hereinbefore is provided, the identification mark and the identification card can, advantageously, be implemented as a unit.

In view of the above-mentioned correlation of the entered object- or person-oriented information with the at least one determined classification feature, an identification on the basis of the correlated classification features can be carried out after a single (active) input of the object- or person-oriented information.

The identification card may, for example, be a reservation ticket for a train, whose owner is guided to his seat, without further active action on his part, when the reservation ticket has been read once (e.g. when the reservation ticket or the ticket is made out) by means of the information reproduced on the Information display devices.

Similarly, it is also possible to guide, e.g. in a park guide system, the driver of a car through a parking garage to his parking place, when a parking ticket has been made out (or when a PIN has been entered by the driver) for the car. When, in addition, the object-oriented device establishes a correlation between the driver and his car, a driver who walks back to his car can be guided back to it.

The above-mentioned object is also achieved by a system comprising at least one information display device and one of the above-described devices for object-oriented control of the at least one information display device.

The information display devices are preferably adapted to be controlled separately by the control means so that different items of information can be displayed simultaneously.

When the control means and the at least one information display device are spatially separated from one another, it will be expedient to connect them via data lines for data transmission, said data lines comprising preferably the internet.

According to an advantageous embodiment, an external evaluation means can be provided, which is connected to the control means via a data line for data transmission and which, e.g. on the basis of a greater computing capacity and/or possibilities of accessing various databases, permits more far-reaching evaluations of the data determined.

It will be particularly advantageous when all or at least part of these data lines comprise the internet, since the provision of data lines and the establishment of an independent network for data transmission can then be dispensed with fully or partly.

Furthermore, a plurality of the above-described display devices can be used for displaying a temporal sequence of information. The temporal sequence can, in particular, be controlled by the classification feature and the identification feature, respectively.

In the following, the invention will be described in detail, making reference to the drawings enclosed, in which:

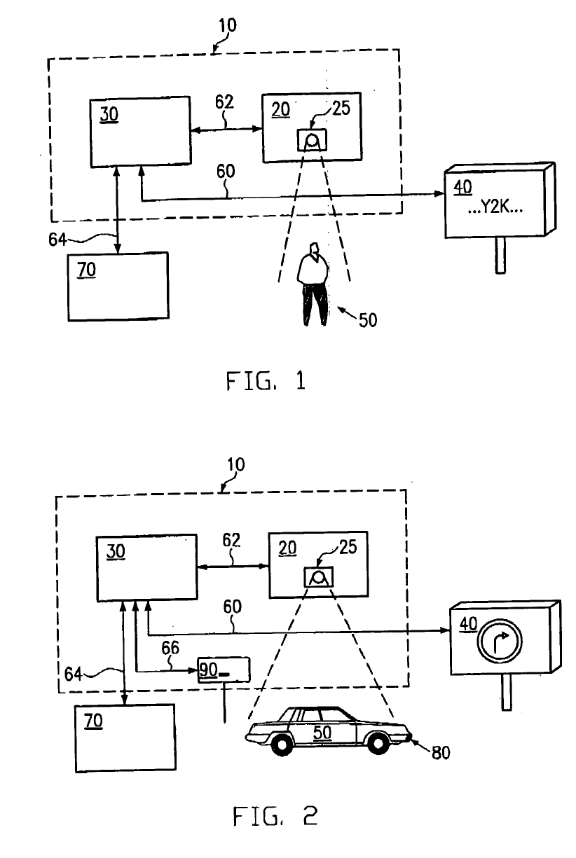

FIG. 1 shows schematically a first embodiment of the present invention for use of a person-oriented control of an information display device; and

FIG. 2 shows schematically a second embodiment of the present invention for use in a parking garage guide system.

FIG. 1 shows an exemplary embodiment of the system according to the present invention in which a device 10 according to the present invention for person-oriented control of at least one information display device 40 and an information display device 40 are interconnected via a data line 60.

A sensor device 20, which comprises a video camera 25 in the present case, detects a person 50 and transmits respective data, e.g. video images, to the control means 30. The control means evaluates the data received and determines the classification features of the person 50 detected.

In the case of person-oriented control, such classification features can be the sex and/or age and/or height and/or weight and/or colour of the skin and/or hair colour and/or nature of dress and/or the ethnic affiliation of persons.

For determining the classification features, various evaluation methods can be used.

Suitable methods are, in particular, visual evaluation methods, which can be executed e.g. on the basis of individual or on the basis of a plurality of recorded video images. The abovementioned classification features can be determined with a very high degree of reliability in this way.

Methods which should be specially emphasized in this connection are biometric evaluation methods and, among these, in particular face recognition methods.

By determining such classification features, the information reproduced by the information display device 40 can be adapted specifically to individual persons or groups of persons.

For such an adaptation, it will be advantageous when the control means 30 carries out a statistical evaluation of the classification features determined, e.g. for ascertaining representative average values. This is important especially for the reproduction of advertising.

In accordance with an embodiment which is not shown and which permits a particularly reliable identification, objects or persons can be equipped with identification marks which are adapted to be detected by the sensor device 20.

If desired or if necessary, also a complete identification of persons and a subsequent control of the information display device can be executable in this way. This can be of advantage e.g. at airports, railways stations, industrial sites, security relevant plants, and in public offices, office buildings, hospitals, etc., and it can be of use to the respective persons themselves and/or to the relevant service staff.

A further adaptation of the information display can be achieved in that classification features determined by the control means 30 are transmitted together with the video images to an external evaluation means 70 which is capable of carrying out more comprehensive and more subtle evaluation methods. In this way, it can, for example, be determined how long certain persons direct their glance at the information display device 40.

This can be used for guaranteeing e.g. an optimum advertising appeal of the information to be reproduced.

FIG. 2 shows an exemplary further embodiment of the system according to the present invention for use as a parking guide system.

In the example shown, a driver inserts a card (identification card, credit card, parking ticket, etc.) into an input device 90 at the entrance to a parking garage or he inputs a code (e.g. PIN code) manually. Simultaneously, he and/or the car are detected by the sensor device 20, and the data determined by the input device 90 and the sensor device 20 are transmitted via data lines 62, 66 to the control means 30 and correlated with one another. When driving on again, the driver and/or the car 50 can be detected through additional sensor devices 20 and identified by the control means, and, by outputting orientation information at information display devices arranged at suitable locations, he can finally be guided to his parking place.

Furthermore, it will be particularly advantageous when person-oriented (driver) and object-oriented (car) data are correlated with one another. This will, for example, also allow a driver who is looking for his car to be guided back to it.

In the present case, the registration number of a vehicle can serve as an identification mark 80. Alternatively, the objects may, however, also have provided thereon identification marks 80, which are specially established for the system.

According to an advantageous embodiment, the classification features determined by the control means (30) can be transmitted to an external evaluation means 70 which is capable of executing more comprehensive evaluation methods, e.g. automatic deduction of parking fees from an account depending the parking time.

1. A device (10) for the object-oriented control of at least one information display device (40), comprising
at least one sensor device (20) for detecting an object (50) or a group of objects; and
a control means (30);
characterized in that
the control means (30) is configured for determining at least one classification feature of at least one object (50) or of the group of objects detected by the at least one sensor device (20) and for controlling the at least one information display device (40) on the basis of the at least one determined classification feature.

2. A device according to claim 1, wherein the at least one sensor device (20) comprises at least one video camera (25) for recording video images and the control means (30) is configured for determining the at least one classification feature from recorded video images of the detected object (50) or group of objects.

3. A device according to claim 2, wherein the control means (30) is configured for determining the at least one classification feature by averaging a plurality of recorded video images of the detected object (50) or group of objects,

4. A device according to one of the preceding claims, which is provided for person-oriented control of the at least one information display device and in which the control means (30) is configured for determining the at least one classification feature of the detected person (50) or group of persons with the aid of a biometric method.

5. A device according to claim 4, wherein the biometric method comprises a face recognition method.

6. A device according to one of the preceding claims, wherein the at least one sensor device (20) is able to detect identification marks (80) provided on the object (50) or the objects, and wherein these identification marks are adapted to be used for the control means (30) for determining the at least one classification feature.

7. A device according to claim 4 or according to one of the claims 5 or 6 in combination with claim 4, wherein the at least one classification feature comprises the sex and/or age and/or height and/or weight and/or colour of the skin and/or hair colour and/or nature of dress and/or the ethnic affiliation and/or the pose of the detected person (50) or group of persons.

8. A device according to one of the preceding claims, wherein the at least one classification feature comprises object features, such as colour, texture, projected shapes, or three-dimensional shapes, etc..

9. A device according to one of the preceding claims, wherein the control means (30) executes a statistical evaluation of the determined classification features of the detected object (50) or group of objects for determining statistical data.

10. A device according to claim 9, wherein the statistical evaluation comprises averaging over a group of objects.

11. A device according to claim 9 or 10, wherein the control means (30) selects the information to be displayed on the basis of the determined statistical data.

12. A device according to one of the claims 9 to 11, wherein the control means (30) stores the determined statistical data and makes them available to an external evaluation means (70).

13. A device according to one of the preceding claims, comprising at least one input device (90) which is connected to the control means (30) via a data line (66) and into which information can be entered, said control means (30) correlating the entered information with the at least one identification feature determined by the at least one sensor device (20).

14. A system comprising
at least one information display device (40); and
a device (10) for object-oriented control of the at least one information display device (40) according to one of the claims 1 to 13.

15. A system according to claim 14 comprising a plurality of information display devices (40) which are adapted to be controlled separately by the control means (30) for displaying different items of information.

16. A system according to claim 14 or 15, wherein the at least one sensor device (20) and/or the at least one information display device (40) are spatially separated from the control means (30) and are connected to said control means (30) via data lines (60, 62) for data transmission.

17. A system according to one of the claims 14 to 16, comprising an external evaluation means (70) which is connected to the control means (30) via a data line (64) for data transmission.

18. A system according to claim 16 or 17, wherein at least one of the data lines (60, 62, 64, 66) for data transmission comprises the internet.
